(19) United States
(12) Patent Application Publication
(10) Pub. No.: US 2022/0009365 A1
(43) Pub. Date: Jan. 13, 2022

(54) VEHICLE

(71) Applicant: TOYOTA JIDOSHA KABUSHIKI KAISHA, Toyota-shi (JP)

(72) Inventor: Toru ANDO, Obu-shi (JP)

(73) Assignee: TOYOTA JIDOSHA KABUSHIKI KAISHA, Toyota-shi (JP)

(21) Appl. No.: 17/322,174

(22) Filed: May 17, 2021

(30) Foreign Application Priority Data
Jul. 13, 2020 (JP) 2020-119681

(51) Int. Cl. B60L 53/16; B60R 25/01; B60R 25/34; B60R 25/20; E05B 77/54; E05B 83/34; E05B 81/56; H01R 13/52

(52) U.S. Cl. CPC B60L 53/16; B60R 25/01; B60R 25/34; H01R 13/5213; E05B 77/54; E05B 83/34; E05B 81/56; B60R 25/2063

(57) ABSTRACT

A vehicle includes a charging port, an electric power storage device configured to be charged with electric power supplied to the charging port from an outside of the vehicle, a charging lid configured to open and close the charging port, a lock device configured to switch between a lock state and an unlock state of the charging lid, and a controller configured to control the lock device. The controller is configured to perform control on the lock device such that switching between the lock state and the unlock state of the charging lid during traveling of the vehicle is not performed.

### CROSS-REFERENCE TO RELATED APPLICATION

This application claims priority to Japanese Patent Application No. 2020-119681 filed on Jul. 13, 2020, incorporated herein by reference in its entirety.

### BACKGROUND

### 1. Technical Field

The present disclosure relates to a vehicle, and in particular, a vehicle including an electric power storage device configured to be charged with electric power supplied to a charging port from the outside of the vehicle.

### 2. Description of Related Art

Japanese Unexamined Patent Application Publication No. 2009-081917 (JP 2009-081917 A) discloses a vehicle in which a charging lid (more specifically, an outlet cover) is switched from an unlock state to a lock state in conjunction with switching of a boarding and unboarding door of the vehicle from an unlock state to a lock state.

### SUMMARY

In the vehicle disclosed in JP 2009-081917 A, in a case where the boarding and unboarding door is switched from the unlock state to the lock state after the vehicle starts to travel, the charging lid may be switched from the unlock state to the lock state during traveling of the vehicle (see S13 of FIG. 3 in JP 2009-081917 A). Hereinafter, switching between the lock state and the unlock state of the boarding and unboarding door is also referred to as “door lock switching”. Sound generated at the time of door lock switching is also referred to as “door lock sound”. Switching between the lock state and the unlock state of the charging lid is also referred to as “lid lock switching”. Sound generated at the time of lid lock switching is also referred to as “lid lock sound”.

In a case where sound other than the door lock sound is generated during traveling of the vehicle, a sense of discomfort tends to be given to an occupant of the vehicle. Although a case where the door lock sound and the lid lock sound are generated simultaneously to suppress a sense of discomfort is also considered, the occupant tends to feel a sense of discomfort even with slight deviation of the timings of both the door lock sound and the lid lock sound, and thus, it is difficult to solve the above-described problem by such a method. The door lock sound and the lid lock sound are generated at different places, and thus, even though the door lock sound the lid lock sound can be generated simultaneously, there is a possibility that the occupant feels a sense of discomfort since the occupant hears sound from a plurality of different places during traveling of the vehicle.

The present disclosure has been accomplished to solve the above-described problem, and an object of the present disclosure is to provide a vehicle capable of restraining a sense of discomfort from being given to an occupant during traveling.

An aspect of the present disclosure relates to a vehicle including a charging port, an electric power storage device, a charging lid, a lock device, and a controller. The electric power storage device is configured to be charged with electric power supplied to the charging port from an outside of the vehicle. The charging lid is configured to open and close the charging port. The lock device is configured to switch between a lock state and an unlock state of the charging lid. The controller is configured to control the lock device. The controller is configured to perform control on the lock device such that switching between the lock state and the unlock state of the charging lid during traveling of the vehicle is not performed.

In the vehicle, lid lock switching (that is, switching between the lock state and the unlock state of the charging lid) is not performed during traveling. For this reason, lid lock sound is not generated during traveling of the vehicle. With the vehicle, it is possible to restrain a sense of discomfort from being given to an occupant due to lid lock sound during traveling.

The charging port may be a charging port for contact charging or may be a charging port for noncontact charging. An opening and closing operation of the charging lid may be a rotation operation or may be a slide operation.

The controller may be configured to, in a case where a predetermined lock trigger is generated when the charging lid is the unlock state, determine whether or not the vehicle is traveling, switch the charging lid from the unlock state to the lock state when determination is made that the vehicle is not traveling, and not perform switching between the lock state and the unlock state of the charging lid when determination is made that the vehicle is traveling.

The controller switches the charging lid from the unlock state to the lock state when the predetermined lock trigger is generated. Note that the controller is configured to not switch the charging lid from the unlock state to the lock state even though the predetermined lock trigger is generated when the vehicle is traveling. According to such a configuration, it is possible to restrain a sense of discomfort from being given to the occupant due to lid lock sound during traveling.

The controller may be configured to, in a case where a predetermined unlock trigger is generated when the charging lid is in the lock state, determine whether or not the vehicle is traveling, switch the charging lid from the lock state to the unlock state when determination is made that the vehicle is not traveling, and not perform switching between the lock state and the unlock state of the charging lid when determination is made that the vehicle is traveling.

The controller is configured to switch the charging lid from the lock state to the unlock state when the predetermined unlock trigger is generated. Note that the controller is configured to not switch the charging lid from the lock state to the unlock state even though the predetermined unlock trigger is generated when the vehicle is traveling. The controller is configured to not perform lid lock switching even though any of the predetermined lock trigger and the predetermined unlock trigger is generated when the vehicle is traveling. According to such a configuration, it is possible to accurately restrain a sense of discomfort from being given to the occupant due to lid lock sound during traveling.

Each of the lock trigger and the unlock trigger can be set optionally. At least one of the lock trigger and the unlock trigger may be set as follows, for example.

At least one of the predetermined lock trigger and the predetermined unlock trigger may be generated when switching between a lock state and an unlock state of a boarding and unboarding door of the vehicle is performed.

The vehicle may further include an input device configured to receive an input from a user. At least one of the predetermined lock trigger and the predetermined unlock trigger may be generated when a predetermined input is performed to the input device.

A method of determining whether or not the vehicle is traveling is optional. The controller may determine whether or not the vehicle is traveling using the following parameters, for example.

The vehicle may further include a traveling drive device configured to generate traveling drive power of the vehicle using electric power supplied from the electric power storage device, and a relay configured to switch between connection and cutoff of an electric power path from the electric power storage device to the traveling drive device. The controller may be configured to determine whether or not the vehicle is traveling using a state of the relay. For example, the controller may be configured to determine that the vehicle is traveling when the relay is in a connection state, and determine that the vehicle is not traveling when the relay is in a cutoff state.

The controller may be configured to determine whether or not the vehicle is traveling using at least one of a state of a start switch of the vehicle, a shift position of the vehicle, and a state of a parking brake of the vehicle.

For example, the controller may be configured to determine that the vehicle is traveling in a period from when the user performs a traveling start operation on the start switch until the user performs a traveling stop operation on the start switch, and determine that the vehicle is not traveling in other periods. The controller may be configured to determine that the vehicle is traveling when the shift position is a traveling range, and determine that the vehicle is not traveling when the shift position is not the traveling range. The controller may be configured to determine that the vehicle is traveling when the parking brake is released, and determine that the vehicle is not traveling when the parking brake is in operation.

The electric power storage device may be configured to supply electric power for traveling of the vehicle. The vehicle may be an electrified vehicle. The electrified vehicle is a vehicle configured to travel using electric power stored in the electric power storage device. The electrified vehicle includes, in addition to an electric vehicle (EV) and a plug-in hybrid vehicle (PHV), a fuel cell vehicle (FC vehicle), a range extender EV, and the like.

According to the aspect of the present disclosure, it is possible to provide a vehicle capable of restraining a sense of discomfort from being given to an occupant during traveling.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram showing the configuration of a vehicle and a charging connector according to an embodiment of the present disclosure;

FIG. 2 is a diagram showing the appearance of the vehicle and the structure of an inlet according to the embodiment of the present disclosure;

FIG. 3 is a time chart showing a first example of the operation of the vehicle according to the embodiment of the present disclosure;

FIG. 4 is a time chart illustrating control according to a comparative example;

FIG. 5 is a time chart showing a second example of the operation of the vehicle according to the embodiment of the present disclosure;

FIG. 6 is a flowchart showing processing of generating a lid lock trigger in the vehicle according to the embodiment of the present disclosure;

FIG. 7 is a flowchart showing lock control of a charging lid that is executed by a controller in the vehicle according to the embodiment of the present disclosure;

FIG. 8 is a flowchart showing details of determination about whether or not the vehicle is traveling in the processing shown in FIG. 7;

FIG. 9 is a flowchart showing processing of generating a lid unlock trigger in the vehicle according to the embodiment of the present disclosure;

FIG. 10 is a flowchart showing unlock control of the charging lid that is executed by the controller in the vehicle according to the embodiment of the present disclosure;

FIG. 11 is a flowchart showing a modification example of the processing shown in FIG. 8;

FIG. 12 is a flowchart showing a modification example of the processing shown in FIG. 7;

FIG. 13 is a diagram showing an example of a screen (notification screen) that is displayed by a notification device in the processing of FIG. 12; and

FIG. 14 is a diagram showing processing that is executed when a door lock trigger is generated in a modification example of the embodiment of the present disclosure.

### DETAILED DESCRIPTION OF EMBODIMENTS

An embodiment of the present disclosure will be described in detail referring to the drawings. The same or similar portions in the drawings are represented by the same reference numerals, and description thereof will not be repeated. Hereinafter, an electronic control unit is referred to as an “ECU”.

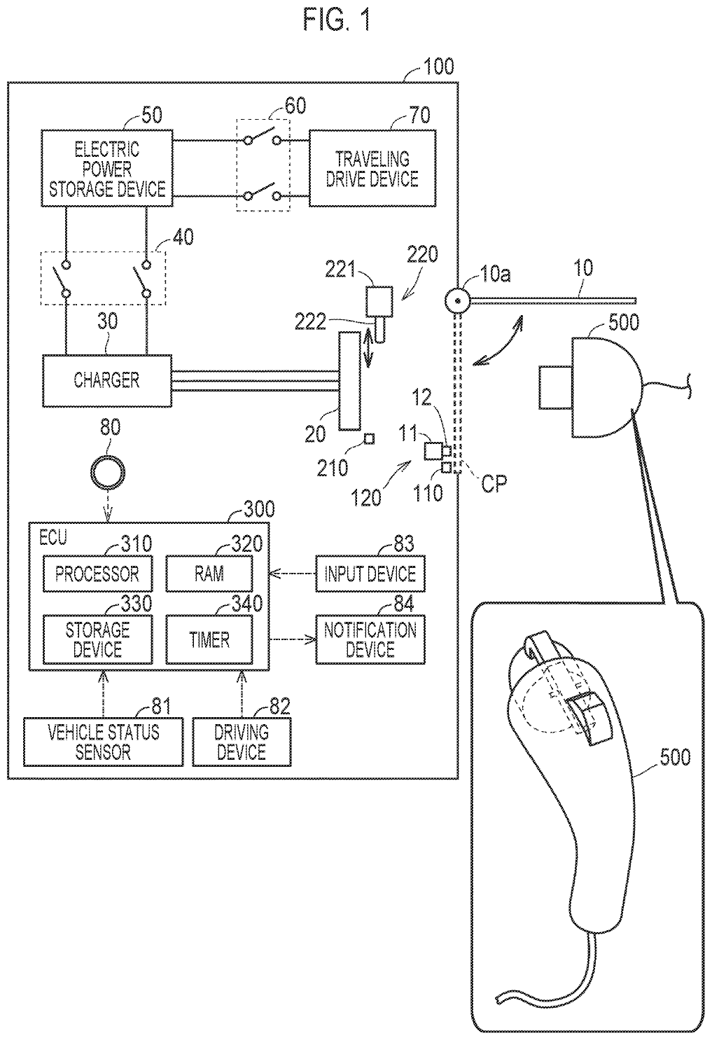

FIG. 1 is a diagram showing the configuration of a vehicle and a charging connector according to the embodiment. Referring to FIG. 1, a vehicle 100 includes a charging lid 10, an inlet 20, a charger 30 (in-vehicle charger), a charging relay 40, an electric power storage device 50, a system main relay (SMR) 60, a traveling drive device 70, a start switch 80, a vehicle status sensor 81, a driving device 82, an input device 83, a notification device 84, an opening and closing sensor 110, a lid lock device (hereinafter, also referred to as an “L-lock device”) 120, a connection sensor 210, a connector lock device (hereinafter, also referred to as a “C-lock device”) 220, and an ECU 300.

The vehicle 100 according to the embodiment is an electric vehicle (EV). The electric power storage device 50 is configured to supply electric power for traveling of the vehicle 100 to the traveling drive device 70. The traveling drive device 70 is configured to generate traveling drive power of the vehicle 100 using electric power supplied from the electric power storage device 50. Details of the configuration of the traveling drive device 70 will be described below. The SMR 60 is configured to switch between connection and cutoff of an electric power path from the electric power storage device 50 to the traveling drive device 70. The SMR 60 and the ECU 300 according to the embodiment correspond to examples of a “relay” and a “controller” according to the present disclosure, respectively.

A charging port CP is formed in a vehicle body of the vehicle 100. The electric power storage device 50 is configured to be charged with electric power supplied to the charging port CP from the outside of the vehicle. Specifically, the inlet 20 is provided inside the charging port CP in the vehicle 100. The inlet 20 is configured such that a charging connector 500 of a charging cable is connectable thereto through the charging port CP. The charging connector 500 is connected to the inlet 20 by a user. The charging connector 500 of the charging cable leading to electric power feed equipment (not shown) provided outside the vehicle is connected to the inlet 20, whereby it is possible to supply electric power from the electric power feed equipment to the inlet 20 through the charging cable. The charger 30 is configured to convert electric power supplied to the inlet 20 into electric power suitable for charging of the electric power storage device 50. The charging relay 40 is configured to switch between connection and cutoff of an electric power path from the charger 30 to the electric power storage device 50. When the charging relay 40 is in an open state (cutoff state), a charging path from the inlet 20 to the electric power storage device 50 is cut off. When the charging relay 40 is in a closed state (connection state), supply of electric power from the inlet 20 to the electric power storage device 50 can be performed. The state (connection and cutoff) of the charging relay 40 is controlled by the ECU 300. In this way, the electric power storage device 50 is configured to perform external charging. External charging in the vehicle 100 means that the electric power storage device 50 is charged with electric power supplied to the inlet 20 from the outside of the vehicle 100.

In the embodiment, the charger 30 is a charger corresponding to AC electric power feed equipment (that is, equipment that feeds alternating-current electric power). For example, the charger 30 may include an electric power conversion circuit that converts alternating-current electric power supplied from the electric power feed equipment (not shown) to the inlet 20 to direct-current electric power, and a filter circuit that eliminates noise. The electric power conversion circuit may be controlled by the ECU 300. Note that the charger 30 is not limited to the above-described configuration and may be a charger corresponding to DC electric power feed equipment (that is, equipment that feeds direct-current electric power). Although solely the inlet 20 is shown in FIG. 1, the vehicle 100 may include a plurality of inlets of respective electric power feed systems to correspond to a plurality of kinds of electric power feed systems (for example, an AC system and a DC system).

The charging lid 10 is configured to open and close the charging port CP. The charging lid 10 is configured to be connected to the vehicle body through an opening and closing mechanism 10a (for example, a hinge) to open and close the charging port CP. In a state in which the charging lid 10 is closed, the charging lid 10 covers the charging port CP, whereby the use of the inlet 20 is prohibited. In a case where the charging lid 10 is brought into an open state, the user can use the inlet 20 outside the vehicle 100. The charging lid 10 is provided with the opening and closing sensor 110. The opening and closing sensor 110 is configured to detect whether the charging lid 10 is in the open state or the closed state and output a detection result to the ECU 300.

The L-lock device 120 is configured to switch between a lock state and an unlock state of the charging lid 10. The lock state is a state in which the charging lid 10 is in the closed state and an opening operation of the charging lid 10 is regulated. The unlock state is a state in which the opening operation of the charging lid 10 is permitted. The L-lock device 120 according to the embodiment corresponding to an example of a “lock device” according to the present disclosure. Hereinafter, in lid lock switching of the charging lid 10, switching of the charging lid 10 from the unlock state to the lock state is referred to as “lid lock”, and switching of the charging lid 10 from the lock state to the unlock state is referred to as “lid unlock”.

The L-lock device 120 includes an actuator 11 and a lock mechanism 12. The lock mechanism 12 is driven by the actuator 11 to regulate the opening operation of the charging lid 10. The actuator 11 is controlled by the ECU 300. In the embodiment, the lock mechanism 12 includes an engagement member (for example, a pin or a hook) to the charging lid 10. Then, the charging lid 10 in the closed state is engaged with the engagement member to regulate the opening operation of the charging lid 10. When the charging lid 10 and the engagement member are not engaged, the opening operation of the charging lid 10 is permitted. The actuator 11 may be a motor that switches between engagement and disengagement of the charging lid 10 and the engagement member by moving the engagement member.

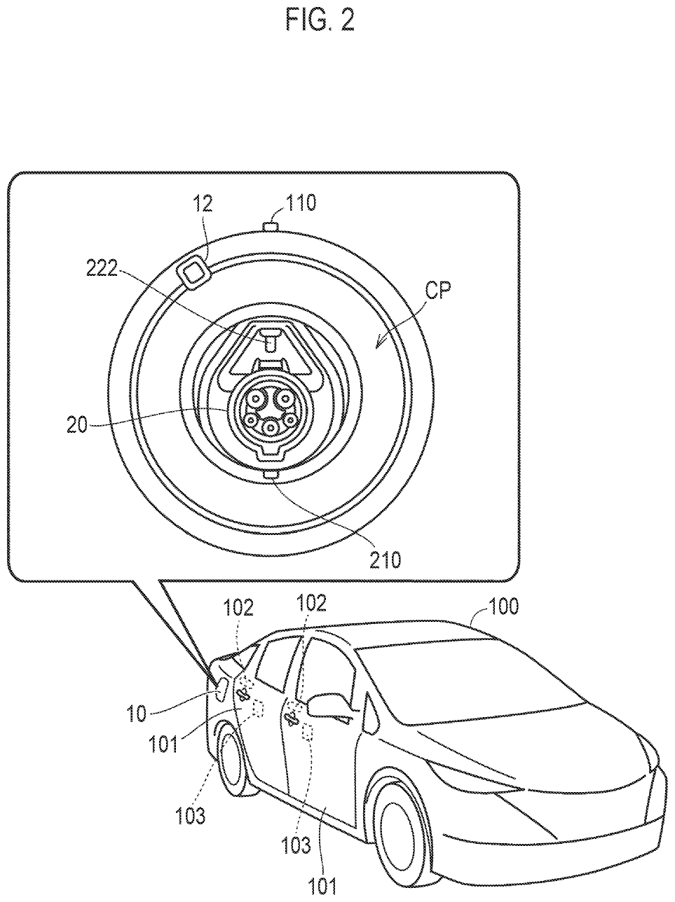

FIG. 2 is a diagram showing the appearance of the vehicle 100 and the structure of the inlet 20. In an upper portion of FIG. 2, the structure of the inlet 20 that is exposed through the charging port CP when the charging lid 10 is opened.

Referring to FIG. 2 along with FIG. 1, the vehicle 100 includes four doors 101. The doors 101 correspond to a boarding and unboarding door. Although solely two doors 101 on a near side are shown in FIG. 2, two doors 101 are present on a back side hidden by the vehicle body. Each door 101 is provided with an opening and closing sensor 102 and a door lock device (hereinafter, also referred to as a “D-lock device”) 103. The opening and closing sensor 102 is configured to detect whether the door 101 is in an open state or a closed state and output a detection result to the ECU 300. The D-lock device 103 is configured to switch between a lock state and an unlock state of the door 101 in response to an instruction from the ECU 300. The lock state is a state in which the door 101 is in the closed state and an opening operation of the door 101 is regulated. The unlock state is a state in which the opening operation of the door 101 is permitted. When the door 101 is in the unlock state, the user can open the door 101 from the outside of the vehicle 100 to board into a vehicle cabin or can open the door 101 from the inside of the vehicle cabin to unboard from the vehicle 100. As the opening and closing sensor 102 and the D-lock device 103, a known sensor and a known lock device can be employed.

Hereinafter, in door lock switching of the door 101, switching of the door 101 from the unlock state to the lock state is referred to as “door lock”, and switching of the door 101 from the lock state to the unlock state is referred to as “door unlock”.

In the embodiment, the charging lid 10 is provided in a vehicle body side surface on a rear side of the vehicle 100. The lock mechanism 12, the inlet 20, the opening and closing sensor 110, the connection sensor 210, and a lock pin 222 are disposed at positions shown in the upper portion of FIG. 2, for example. Note that the present disclosure is not limited thereto, and the position of each of the charging lids 10, the lock mechanism 12, the inlet 20, the opening and closing sensor 110, the connection sensor 210, and the lock pin 222 can be set optionally.

Referring to FIG. 1 again, the inlet 20 is provided with the connection sensor 210 and the C-lock device 220. The connection sensor 210 is configured to detect whether or not the charging connector 500 is connected to the inlet 20, and output a detection result to the ECU 300. The C-lock device 220 is configured to switch between a lock state and an unlock state of the charging connector 500. The lock state is a state in which the charging connector 500 is connected to the inlet 20 and detachment of the charging connector 500 from the inlet 20 is regulated. The unlock state is a state in which detachment of the charging connector 500 from the inlet 20 is permitted. In the embodiment, the C-lock device 220 includes an actuator 221 and the lock pin 222. The lock pin 222 is driven by the actuator 221 to regulate detachment of the charging connector 500. The actuator 221 is controlled by the ECU 300.

When the vehicle 100 travels, the SMR 60 is brought into a closed state, and electric power is supplied from the electric power storage device 50 to the traveling drive device 70. The state of the SMR 60 is controlled by the ECU 300. As the SMR 60, for example, an electromagnetic type mechanical relay can be employed. When the SMR 60 is in the closed state (connection state), transfer of electric power between the electric power storage device 50 and the traveling drive device 70 can be performed. When the SMR 60 is in an open state (cutoff state), a current is cut off by the SMR 60.

The traveling drive device 70 includes a power control unit (PCU) and a motor generator (MG) (not shown). The MG is, for example, a three-phase alternating-current motor generator. The PCU includes a converter and an inverter that are controlled by the ECU 300. At the time of power drive of the MG, the PCU converts electric power stored in the electric power storage device 50 into alternating-current electric power and supplies alternating-current electric power to the MG, and the MG rotates drive wheels of the vehicle 100 using supplied electric power. At the time of power generation by the MG (for example, at the time of regenerative braking), the PCU rectifies generated electric power and supplies electric power to the electric power storage device 50.

The electric power storage device 50 includes, for example, a secondary battery, such as a lithium-ion battery or a nickel-hydrogen battery, and a monitoring unit that monitors the state of the electric power storage device 50 (both are not shown). The secondary battery may be an assembled battery. Other electric power storage devices, such as an electric double layer capacitor, may be employed instead of the secondary battery. The monitoring unit includes various sensors that detect the state (for example, a temperature, a current, and a voltage) of the electric power storage device 50, and outputs detection results to the ECU 300. The monitoring unit may be a battery management system (BMS) further having a state of charge (SOC) estimation function, a state of health (SOH) estimation function, an equalization function of a cell voltage in an assembled battery, a diagnosis function, and a communication function in addition to the above-described sensor function.

The ECU 300 includes a processor 310, a random access memory (RAM) 320, a storage device 330, and a timer 340. As the processor 310, for example, a central processing unit (CPU) can be employed. The RAM 320 functions as a work memory that temporarily stores data processed by the processor 310. The storage device 330 is configured to save stored information. The storage device 330 includes, for example, a read only memory (ROM) and a rewritable nonvolatile memory. In the storage device 330, in addition to programs, information (for example, maps, numerical expressions, and various parameters) for use in the programs is stored. In the embodiment, various kinds of control in the ECU 300 are executed by the processor 310 executing the programs stored in the storage device 330. Note that various kinds of control in the ECU 300 are not limited as being executed by software, and can also be executed by dedicated hardware (electronic circuit). The number of processors in the ECU 300 is optional, and a processor may be prepared for each predetermined control.

The timer 340 is configured to inform the processor 310 of the incoming of a set time. In a case where the time set in the timer 340 is reached, a signal for informing of the effect is transmitted from the timer 340 to the processor 310. In the embodiment, a timer circuit is employed as the timer 340. Note that the timer 340 may be realized by software, not hardware (timer circuit). The ECU 300 can acquire a current time using a real time clock (RTC) circuit (not shown) incorporated in the ECU 300.

The start switch 80 is a switch for starting a vehicle system, and the start switch 80 is turned on to start the vehicle system (including the ECU 300). The start switch 80 is generally referred to as a “power switch” or an “ignition switch”. In the embodiment, the vehicle system starts in a case where the vehicle 100 is brought into a Ready-ON state described below, and the vehicle system is brought into a stop state (including a sleep state) in a case where the vehicle 100 is brought into a Ready-OFF state described below.

In a case where the user performs a traveling start operation on the start switch 80, the vehicle 100 is brought into the Ready-ON state. In the Ready-ON state, the SMR 60 is brought into the closed state, and electric power is supplied from the electric power storage device 50 to the traveling drive device 70. In the Ready-ON state, the ECU 300 can perform control on the traveling drive device 70 to make the vehicle 100 travel. In a case where the user performs a traveling stop operation on the start switch 80 when the vehicle 100 is in the Ready-ON state, the vehicle 100 is brought into the Ready-OFF state. In the Ready-OFF state, the SMR 60 is brought into the open state, and electric power is not supplied from the electric power storage device 50 to the traveling drive device 70. Hereinafter, a period from when the user performs the traveling start operation on the start switch 80 until the user performs the traveling stop operation on the start switch 80 is referred to as a “traveling period”.

In the embodiment, although a system start operation and a system stop operation are the same as the traveling start operation and the traveling stop operation, respectively, the system start operation and the system stop operation may be operations different from the traveling start operation and the traveling stop operation, respectively. For example, in a case where the start switch 80 is pressed in a system stop state, the vehicle system may start, and in a case where the start switch 80 is pressed once more after the system starts, the vehicle 100 may be brought into the Ready-ON state.

The vehicle status sensor 81 is a sensor group that detects the status of the vehicle 100. In the embodiment, the vehicle status sensor 81 includes various sensors (for example, an outside air temperature sensor, an outside air pressure sensor, and an obstacle detector) that monitors the environment of the vehicle 100, and various sensors (for example, a vehicle speed sensor, a position sensor, a steering angle sensor, and an odometer) that monitors traveling of the vehicle 100.

The driving device 82 is a device that receives a driving operation (for example, an operation regarding each of shift changes, an accelerator, a brake, steering, and vehicle fixing) of the vehicle 100 by the user. The driving device 82 outputs a signal corresponding to the driving operation of the user to the ECU 300. The ECU 300 performs traveling control of the vehicle 100 based on the signal received from the driving device 82. In the embodiment, the driving device 82 includes a shift lever, an accelerator pedal, a brake pedal, a steering wheel, and a parking brake. The user can change a shift position of the vehicle 100 by operating the shift lever. The user can strengthen or weaken acceleration of the vehicle 100 by operating the accelerator pedal. The user can strengthen or weaken braking of the vehicle 100 by operating the brake pedal. The user can adjust an angle (steering angle) of the steering wheel of the vehicle 100 by operating the steering wheel. The user can fix or unfix the vehicle 100 by operating the parking brake.

The input device 83 is a device that receives an input other than the driving operation by the user. The input device 83 outputs a signal corresponding to the input of the user to the ECU 300. The user can perform a predetermined instruction or request or can set values of parameters through the input device 83. A communication system may be a wired system or a wireless system. Examples of the input device 83 include various switches, various pointing devices, a keyboard, and a touch panel. The input device 83 may be a smart speaker that receives a voice input. The input device 83 may be an operating unit of a car navigation system.

In the embodiment, the input device 83 includes a door lock dedicated switch (hereinafter, referred to as “D-lock SW”), a door unlock dedicated switch (hereinafter, referred to as a “D-unlock SW”), a lid lock dedicated switch (hereinafter, referred to as an “L-lock SW”), a lid unlock dedicated switch (hereinafter, referred to as an “L-unlock SW”).

The D-lock SW and the D-unlock SW are switches that are provided for the user instructing the ECU 300 to perform door lock and door unlock, respectively. In a case where the D-lock SW is operated by the user, the ECU 300 performs control such that the D-lock device 103 (FIG. 2) brings the door 101 (FIG. 2) into the lock state. In a case where the D-unlock SW is operated by the user, the ECU 300 performs control such that the D-lock device 103 (FIG. 2) brings the door 101 (FIG. 2) into the unlock state. Each of the D-lock SW and the D-unlock SW may be provided in knobs (both the inside and the outside) of each door 101, for example.

Although details will be described below, the L-lock SW and the L-unlock SW are switches that are provided for the user instructing the ECU 300 to perform lid lock and lid unlock, respectively. In a case where the L-lock SW is operated by the user, a predetermined signal (hereinafter, referred to as a “user lock instruction”) is output to the ECU 300. In a case where the L-unlock SW is operated by the user, a predetermined signal (hereinafter, referred to as a “user unlock instruction”) is output to the ECU 300. Each of the L-lock SW and the L-unlock SW may be provided in the vehicle cabin of the vehicle 100, for example.

The notification device 84 is configured to execute predetermined notification processing when there is a request from the ECU 300. Examples of the notification device 84 include a display device (for example, a meter panel or a head-up display), a speaker, and a lamp. The notification device 84 may be a display unit of the car navigation system.

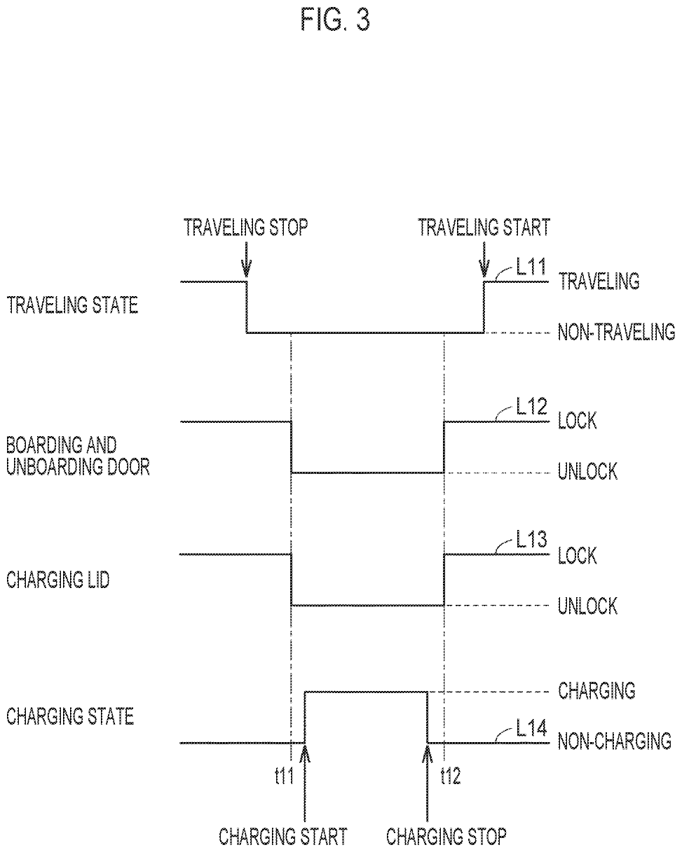

Hereinafter, an operation from when the vehicle 100 performs external charging after stopping traveling until the vehicle 100 starts traveling again will be described referring to FIG. 3 along with FIG. 1. FIG. 3 is a time chart showing a first example of the operation of the vehicle 100 according to the embodiment. In FIG. 3, lines L11, L12, L13, L14 are transition of the traveling state (traveling and non-traveling) of the vehicle 100, the state (lock and unlock) of the door 101, the state (lock and unlock) of the charging lid 10, and a charging state (charging and non-charging) of the electric power storage device 50, respectively.

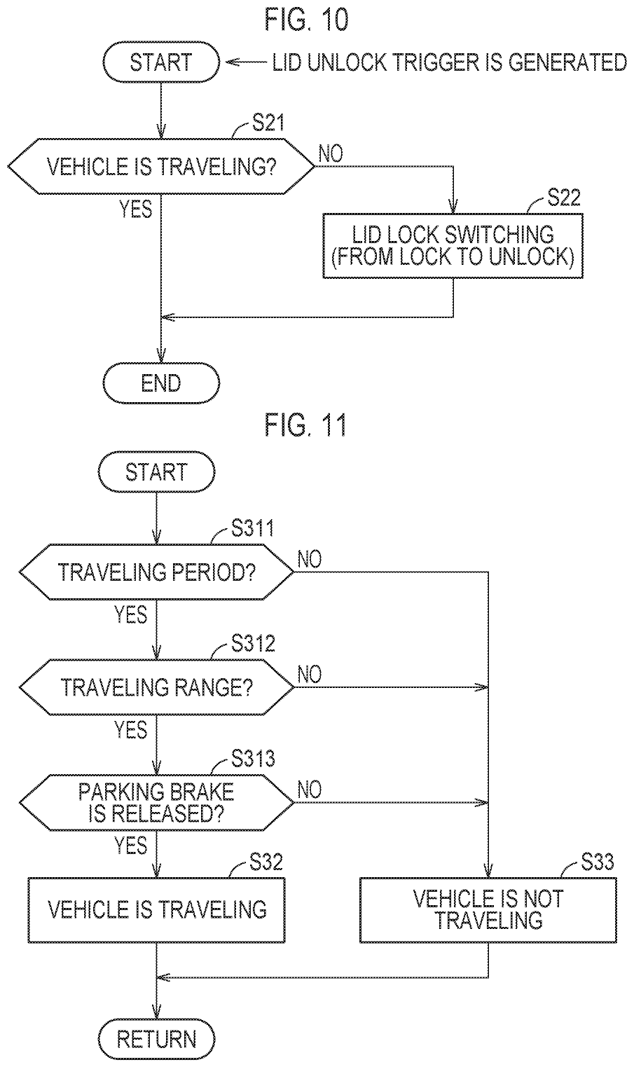

In the example shown in FIG. 3, when the vehicle 100 is traveling, each of the door 101 and the charging lid 10 is brought into the lock state (see lines L12, L13). The user parks the vehicle 100 near the electric power feed equipment and performs the traveling stop operation on the start switch 80. With this, the vehicle 100 is brought into the Ready-OFF state (that is, a state in which electric traveling is not possible), and the traveling period of the vehicle 100 ends (line L11). Thereafter, at timing 01, the user operates the D-unlock SW to bring the door 101 into the unlock state (line L12). The charging lid 10 is also switched from the lock state to the unlock state in conjunction with switching of the door 101 from the lock state to the unlock state (line L13). In this case, although door unlock and lid unlock are substantially performed simultaneously, lid unlock is executed slightly later than door unlock. Details of the unlock control of the charging lid 10 will be described below (see FIGS. 9 and 10).

In a case where the door 101 is brought into the unlock state, the user opens the door 101 to go outside the vehicle and connected the charging connector 500 of the charging cable leading to the electric power feed equipment to the inlet 20. In a case where the charging connector 500 is connected to the inlet 20, the ECU 300 performs control such that the C-lock device 220 brings the charging connector 500 into the lock state. With this, it is possible to supply electric power from the electric power feed equipment to the inlet 20 through the charging cable. In a case where a preparation of external charging is completed, the user operates the electric power feed equipment to start external charging of the electric power storage device 50 (line L14). Thereafter, the user stops external charging at a desired timing (line L14).

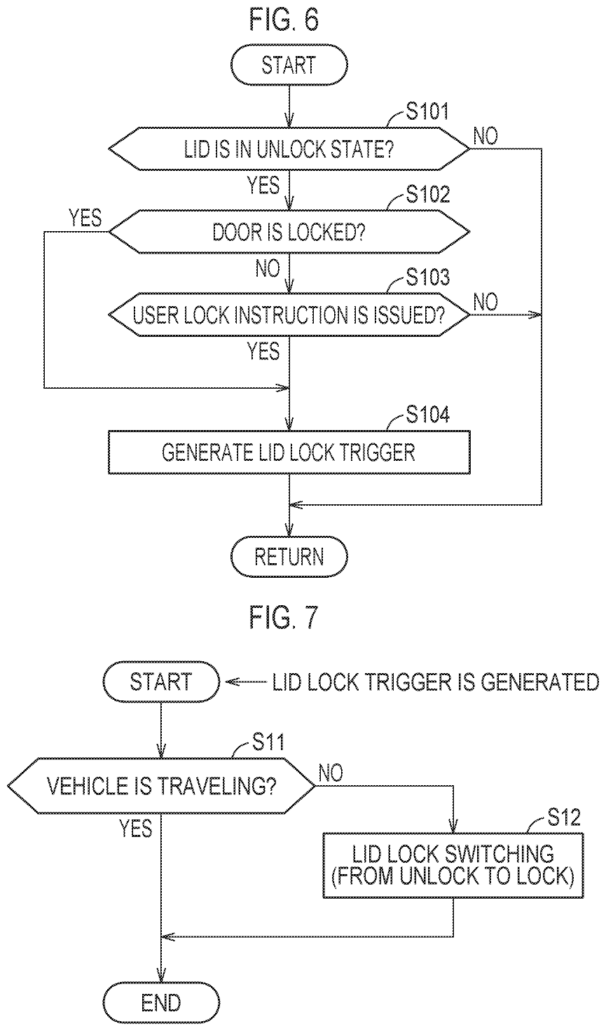

In a case where external charging ends, the user boards the vehicle 100 and closes the door 101. Then, at timing t12, the user operates the D-lock SW to bring the door 101 into the lock state (line L12). The charging lid 10 is also switched from the unlock state to the lock state in conjunction with switching of the door 101 from the unlock state to the lock state (line L13). In this case, although door lock and lid lock are substantially performed simultaneously, lid lock is executed slightly later than door lock. Details of the lock control of the charging lid 10 will be described below (see FIGS. 6 and 7).

The user brings the door 101 into the lock state as described below, and then, performs the traveling start operation on the start switch 80. With this, the vehicle 100 is brought into the Ready-ON state (that is, a state in which electric traveling is possible), and the traveling period of the vehicle 100 starts (line L11).

As described above, the ECU 300 according to the embodiment is configured to perform lid lock switching (that is, switching between the lock state and the unlock state of the charging lid 10) in conjunction with door lock switching (that is, switching between the lock state and the unlock state of the door 101). Note that the ECU 300 does not perform lid lock switching during traveling of the vehicle 100. Hereinafter, the effects derived from such control will be described by comparison with control according to a comparative example.

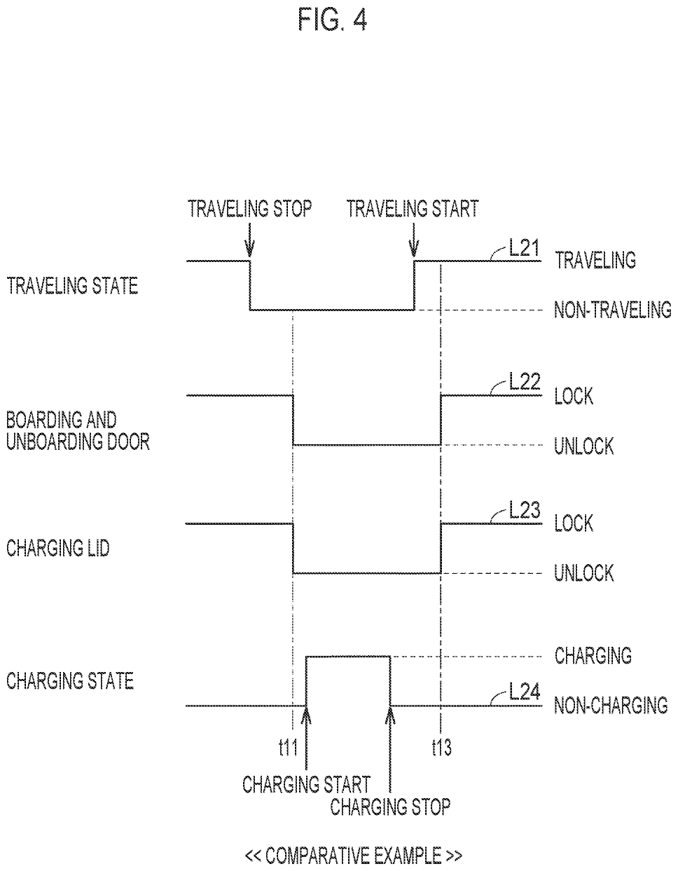

FIG. 4 is a time chart illustrating the control according to the comparative example. In the control according to the comparative example, lid lock switching is performed in conjunction with door lock switching regardless of whether or not the vehicle 100 is traveling. Lines L21, L22, L23, L24 in FIG. 4 correspond to the lines L11, L12, L13, L14 in FIG. 3, respectively.

In the example shown in FIG. 4, the user starts traveling of the vehicle 100 starts before performing door lock. Then, door lock is performed at timing t13 after the start of traveling (line L22). Door lock during traveling of the vehicle may be performed by a user operation or may be automatically performed in a case where a predetermined door lock condition is established. For example, the door lock condition may be established in a case where a vehicle speed is equal to or higher than a predetermined value.

In the control according to the comparative example, lid lock is performed in conjunction with door lock (line L23). Although door lock and lid lock are substantially performed simultaneously, lid lock is executed slightly later than door lock.

As described above, in the control according to the comparative example, lid lock is performed during traveling of the vehicle 100. In a case where lid lock sound is generated during traveling of the vehicle 100, a sense of discomfort may be given to an occupant of the vehicle 100. In particular, in an EV, since there is no engine sound at the time of traveling and it is quiet, a sense of discomfort is likely to be given to the occupant. In a case where different kinds of operation sound (door lock sound and lid lock sound) are substantially generated simultaneously during traveling of the vehicle 100, there is a possibility that the user is confused with abnormal noise (sound at abnormal) of a traveling drive system and misunderstands that an abnormality occurs in the traveling drive system.

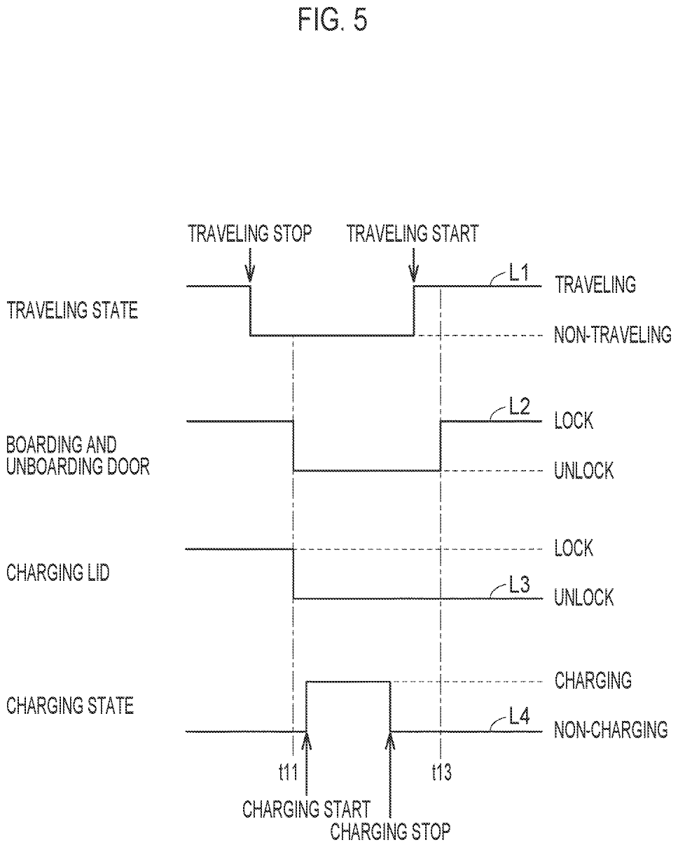

Accordingly, in the embodiment, the ECU 300 performs control on the L-lock device 120 such that lid lock switching is not performed during traveling of the vehicle 100. Hereinafter, control according to the embodiment will be described referring to FIG. 5 along with FIG. 1. FIG. 5 is a time chart showing a second example of the operation of the vehicle 100 according to the embodiment. Lines L1, L2, L3, L4 in FIG. 5 correspond to the lines line L11, L12, L13, L14 in FIG. 3, respectively.

In the example shown in FIG. 5, as in the example shown in FIG. 4, the user starts traveling of the vehicle 100 before performing door lock. Then, door lock is performed at timing t13 after the start of traveling (line L2). However, the ECU 300 does not perform lid lock switching during traveling of the vehicle 100. For this reason, lid lock is not performed even though door lock is performed at timing t13 (line L3).

As described above, in the control according to the embodiment, lid lock switching is not performed during traveling. For this reason, lid lock sound is not generated during traveling of the vehicle 100. With such control, it is possible to restrain a sense of discomfort from being given to the occupant during traveling of the vehicle 100. Sound that is confused with abnormal noise of the traveling drive system is restrained from being generated during traveling of the vehicle 100. For this reason, the user easily notices an abnormality of the traveling drive system of the vehicle 100 with change in sound during traveling.

The ECU 300 according to the embodiment determines whether or not the vehicle 100 is traveling in a case where a lid lock trigger is generated when the charging lid 10 is in the unlock state, switches the charging lid 10 from the unlock state to the lock state when determination is made that the vehicle 100 is not traveling, and does not perform lid lock switching when determination is made that the vehicle 100 is traveling. The lid lock trigger according to the embodiment corresponds to an example of a “lock trigger” according to the present disclosure.

FIG. 6 is a flowchart showing processing of generating the lid lock trigger. The processing shown in the flowchart is repeatedly executed by the ECU 300.

Referring to FIG. 6 along with FIG. 1, in Step (hereinafter, simply referred to as “S”) 101, the ECU 300 determines whether or not the charging lid 10 is in the unlock state. When the charging lid 10 is in the unlock state (in S101, YES), the process progresses to S102. In a case where the charging lid 10 is in the lock state (in S101, NO), processing of S102 and subsequent steps is not executed.

In S102, the ECU 300 determines whether or not door lock is performed from a previous processing routine until a present processing routine.

In a case where determination of NO (door lock is not performed) is made in S102, in S103, the ECU 300 determines whether or not the user lock instruction is received from the L-lock SW from the previous processing routine until the present processing routine.

In a case where determination of YES is made in any of S102 and S103, the lid lock trigger is generated in S104. In a case where determination of NO (the user lock instruction is not received) is made in S103, the process returns to the initial step (S101).

As described above, the lid lock trigger is not generated when the charging lid 10 is not in the unlock state (in S101, NO). The lid lock trigger is generated when the boarding and unboarding door (door 101) of the vehicle 100 is switched from the unlock state to the lock state (in S102, YES). The lid lock trigger is generated when a predetermined input is performed to the input device 83 (for example, the L-lock SW) (in S103, YES).

In a case where the lid lock trigger is generated in S104 of FIG. 6, processing shown in FIG. 7 described below is executed. FIG. 7 is a flowchart showing the lock control of the charging lid 10 that is executed by the ECU 300.

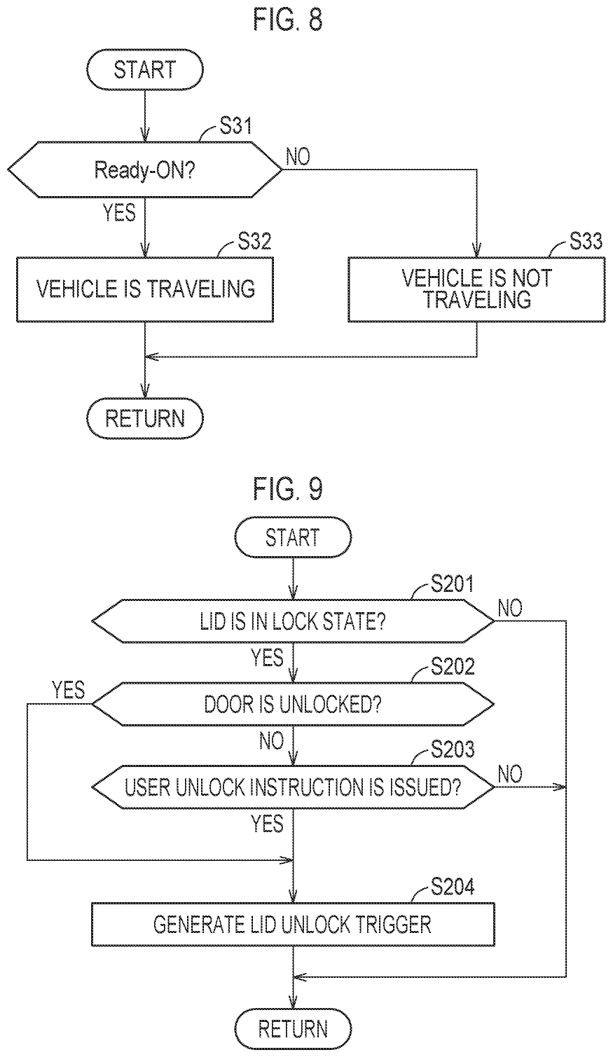

Referring to FIG. 7 along with FIG. 1, in S11, the ECU 300 determines whether or not the vehicle 100 is traveling. The ECU 300 determines whether or not the vehicle 100 is traveling through processing shown in FIG. 8 described below, for example. FIG. 8 is a flowchart showing details of S11 of FIG. 7.

Referring to FIG. 8 along with FIG. 1, in S31, the ECU 300 determines whether or not the vehicle 100 is in the Ready-ON state. Specifically, when the SMR 60 is in the closed state, in S31, the ECU 300 determines that the vehicle 100 is in the Ready-ON state. When the SMR 60 is in the open state, in S31, the ECU 300 determines that the vehicle 100 is in the Ready-OFF state.

When the vehicle 100 is in the Ready-ON state (in S31, YES), in S32, the ECU 300 determines that the vehicle 100 is traveling (that is, in S11 of FIG. 7, YES). When the vehicle 100 is in the Ready-OFF state (in S31, NO), in S33, the ECU 300 determines that the vehicle 100 is not traveling (that is, in S11 of FIG. 7, NO).

Referring to FIG. 7 along with FIG. 1 again, when determination of YES (traveling) is made in S11, the ECU 300 ends a series of processing shown in FIG. 7 without performing lid lock switching. When determination of NO (non-traveling) is made in S11, in S12, the ECU 300 performs control such that the L-lock device 120 performs lid lock (that is, processing of switching the charging lid 10 from the unlock state to the lock state).

Next, the unlock control of the charging lid 10 according to the embodiment will be described. The ECU 300 according to the embodiment determines whether or not the vehicle 100 is traveling in a case where a lid unlock trigger is generated when the charging lid 10 is in the lock state, switches the charging lid 10 from the lock state to the unlock state when determination is made that vehicle 100 is not traveling, and does not perform lid lock switching when determination is made that the vehicle 100 is traveling. The lid unlock trigger according to the embodiment corresponds to an example of an “unlock trigger” according to the present disclosure.

FIG. 9 is a flowchart showing processing of generating the lid unlock trigger. The processing shown in the flowchart is repeatedly executed by the ECU 300.

Referring to FIG. 9 along with FIG. 1, in S201, the ECU 300 determines whether or not the charging lid 10 is in the lock state. When the charging lid 10 is in the lock state (in S201, YES), the process progresses to S202. When the charging lid 10 is in the unlock state (in S201, NO), processing of S202 and subsequent steps is not executed.

In S202, the ECU 300 determines whether or not door unlock is performed from a previous processing routine until a present processing routine.

In a case where determination of NO (door unlock is not performed) is made in S202, in S203, the ECU 300 determines whether or not the user unlock instruction is received from the L-unlock SW from the previous processing routine until the present processing routine.

In a case where determination of YES is made in any of S202 and S203, the lid unlock trigger is generated in S204. In a case where determination of NO (the user unlock instruction is not received) is made in S203, the process returns to the initial step (S201).

As described above, the lid unlock trigger is not generated when the charging lid 10 is not in the lock state (in S201, NO). The lid unlock trigger is generated when the boarding and unboarding door (door 101) of the vehicle 100 is switched from the lock state to the unlock state (in S202, YES). The lid unlock trigger is generated when a predetermined input is performed to the input device 83 (for example, the L-unlock SW) (in S203, YES).

In a case where the lid unlock trigger is generated in S204 of FIG. 9, processing shown in FIG. 10 described below is executed. FIG. 10 is a flowchart showing the unlock control of the charging lid 10 that is executed by the ECU 300.

Referring to FIG. 10 along with FIG. 1, in S21, the ECU 300 determines whether or not the vehicle 100 is traveling. The ECU 300 determines whether or not the vehicle 100 is traveling through the processing shown in FIG. 8, for example.

When determination of YES (traveling) is made in S21, the ECU 300 ends a series of processing shown in FIG. 10 without performing lid lock switching. When determination of NO (non-traveling) is made in S21, in S22, the ECU 300 performs control such that the L-lock device 120 performs lid unlock (that is, processing of switching the charging lid 10 from the lock state to the unlock state).

As described above, the ECU 300 according to the embodiment does not perform lid lock switching (lid lock and lid unlock) during traveling of the vehicle 100. For this reason, even though door lock or door unlock is performed during traveling of the vehicle 100, and even though the user erroneously operates the L-lock SW or the L-unlock SW during traveling of the vehicle 100, lid lock sound is not generated. With such control, the ECU 300 can restrain a sense of discomfort from being given to the occupant during traveling of the vehicle 100. In the control of the L-lock device 120 according to the embodiment, an operation frequency of the L-lock device 120 is reduced compared to the control (that is, control in which door lock and lid lock are constantly performed in conjunction) according to the comparative example. Therefore, in the vehicle 100 according to the embodiment, durability requested for the L-lock device 120 decreases. For this reason, it is possible to achieve reduction in cost by employing the inexpensive L-lock device 120.

In the above-described embodiment, the ECU 300 determines whether or not the vehicle 100 is traveling solely using the state (connection and cutoff) of the SMR 60 (see FIG. 8). However, a method of determining whether or not the vehicle 100 is traveling is not limited to the above-described method. For example, the ECU 300 may determine whether or not the vehicle 100 is traveling using at least one of the state of the start switch 80, the shift position of the vehicle 100, and the state of the parking brake of the vehicle 100 instead of or in addition to the state of the SMR 60.

The ECU 300 may execute processing shown in FIG. 11 instead of the processing shown in FIG. 8. FIG. 11 is a flowchart showing a modification example of the processing shown in FIG. 8.

Referring to FIG. 11 along with FIG. 1, in S311, the ECU 300 determines whether or not the vehicle is within the traveling period (that is, a period from when the user performs the traveling start operation on the start switch 80 until the user performs the traveling stop operation on the start switch 80).

In S312, the ECU 300 determines whether or not the shift position of the vehicle 100 is a traveling range.

In S313, the ECU 300 determines whether or not the parking brake of the vehicle 100 is released.

When determination of YES (the vehicle is within the traveling period, the shift position is the traveling range, and the parking brake is released) is made in all of S311 to S313, in S32, the ECU 300 determines that the vehicle 100 is traveling (that is, in S11 of FIG. 7, YES). When determination of NO is made in any of S311 to S313, the ECU 300 determines in S33 that the vehicle 100 is not traveling (that is, NO in S11 of FIG. 7).

In the above-described embodiment, when the lid lock trigger is generated during traveling of the vehicle 100 (YES in S11 of FIG. 7), no processing is executed. When the lid unlock trigger is generated during traveling of the vehicle 100 (YES in S21 of FIG. 10), no processing is executed. Note that the present disclosure is not limited thereto, and when the lid lock trigger or the lid unlock trigger is generated during traveling of the vehicle 100, predetermined processing may be executed.

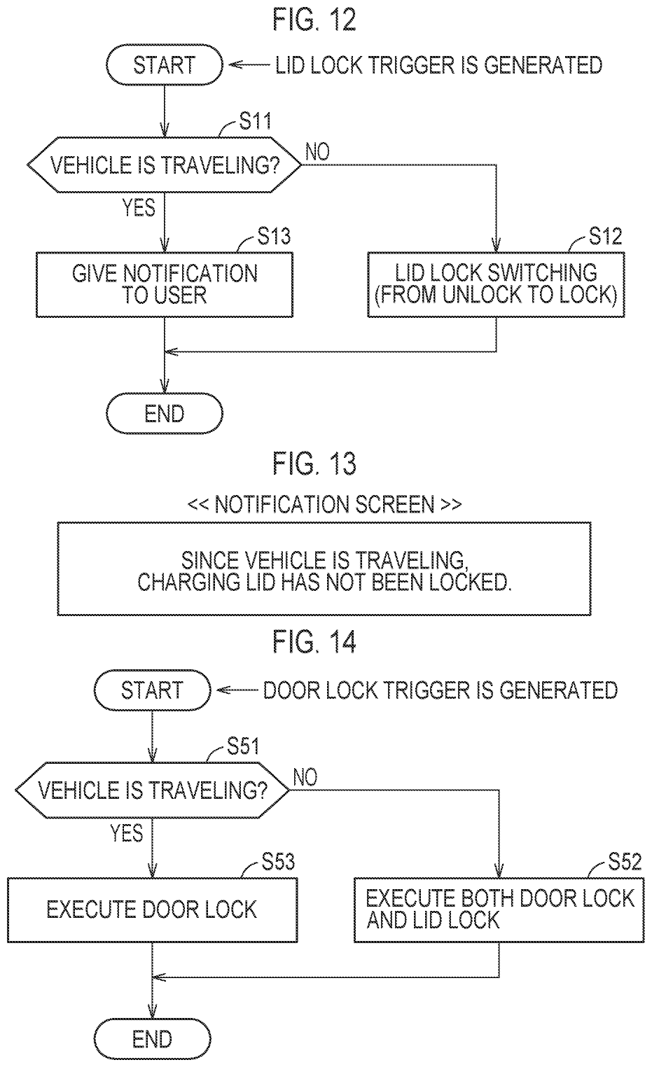

The ECU 300 may execute processing shown in FIG. 12 instead of the processing shown in FIG. 7. FIG. 12 is a flowchart showing a modification example of the processing shown in FIG. 7. In the processing shown in FIG. 12, S13 is added to the processing shown in FIG. 7.

Referring to FIG. 12 along with FIG. 1, when lid lock trigger is generated during traveling of the vehicle 100, determination of YES is made in S11, and the process progresses to S13. In S13, the ECU 300 performs control such that the notification device 84 notifies the user that lid lock is not performed. The notification device 84 displays, for example, a screen for notifying the user that lid lock is not performed.

FIG. 13 is a diagram showing an example of the screen (notification screen) that is displayed by the notification device 84 in S13 of FIG. 12. Referring to FIG. 13, the screen displays a message for informing the user that lid lock is not performed since the vehicle is traveling.

A notification method is optional, and the user may be informed through display (for example, display of a character or an image) on a display device, the user may be notified through sound (including voice) from a speaker, or a predetermined lamp may be turned on (including blinking).

Although FIG. 12 shows the modification example about the lock control of the charging lid 10, the same modification may be made to unlock control of the charging lid 10.

A condition under which the lid lock trigger is generated is not limited to the condition shown in FIG. 6 and is optional. For example, S102 or S103 in the processing of FIG. 6 may be omitted. A condition under which the lid unlock trigger is generated is not limited to the condition shown in FIG. 9 and is optional. For example, S202 or S203 in the processing of FIG. 9 may be omitted.

In the above-described embodiment, although the ECU 300 separately performs the lock control (FIG. 7) and the unlock control (FIG. 10) of the charging lid 10, the present disclosure is not limited to such a control aspect. As long as the ECU 300 may perform control on the L-lock device 120 such that lid lock switching is not performed even though a trigger of lid lock switching is generated during traveling of the vehicle 100, the control aspect is optional.

In the above-described embodiment, when the lid lock trigger is generated, the processing shown in FIG. 7 is executed. Note that the present disclosure is not limited thereto and the ECU 300 may be configured to execute processing shown in FIG. 14 described below when a predetermined door lock trigger is generated. In a modification example where processing shown in FIG. 14 is executed, the ECU 300 may not execute the processing shown in FIGS. 6 and 7. FIG. 14 is a diagram showing processing that is executed when the door lock trigger is generated in the modification example of the above-described embodiment.

Referring to FIG. 14, in S51, the ECU 300 determines whether or not the vehicle 100 is traveling. When determination of NO (non-traveling) is made in S51, in S52, the ECU 300 performs control on the D-lock device 103 and the L-lock device 120 to perform both door lock and lid lock. On the other hand, when determination of YES (traveling) is made in S51, in S53, the ECU 300 performs control on the D-lock device 103 to perform solely door lock between door lock and lid lock. That is, in S53, lid lock switching is not performed.

The above-described door lock trigger may be generated when the user performs a predetermined operation on the D-lock SW, may be generated when the vehicle speed is equal to or higher than a predetermined value, or may be generated when the shift position is the traveling range. Although FIG. 14 shows the modification example about the lock control of the charging lid 10, the same modification may be made to the unlock control of the charging lid 10.

The configuration of the vehicle is not limited to the configuration shown in FIGS. 1 and 2. The traveling drive device 70 may further include an engine (internal combustion engine) (not shown). The vehicle may be a plug-in hybrid vehicle (PHV) that can travel using both electric power stored in the electric power storage device 50 and an output of the engine. The vehicle may be a passenger vehicle, may be a bus, or may be a truck. The vehicle may be configured to be charged in a noncontact manner. The vehicle may be configured to travel in an unmanned manner by autonomous driving or remote driving. The vehicle may be an automatic guided vehicle (AGV) or may be a Mobility as a Service (MaaS) vehicle that is managed by a MaaS provider. The number of wheels is not limited to four and can be suitably changed. The number of wheels may be three or may be five or more.

The embodiment disclosed herein is to be considered merely illustrative and not restrictive in all respects. The scope of the present disclosure is defined by the terms of the claims, rather than the above description of the embodiment, and is intended to include any modifications within the scope and meaning equivalent to the terms of the claims.

What is claimed is:

1. A vehicle comprising:
a charging port;
an electric power storage device configured to be charged with electric power supplied to the charging port from an outside of the vehicle;
a charging lid configured to open and close the charging port;
a lock device configured to switch between a lock state and an unlock state of the charging lid; and
a controller configured to control the lock device,
wherein the controller is configured to perform control on the lock device such that switching between the lock state and the unlock state of the charging lid during traveling of the vehicle is not performed.

2. The vehicle according to claim 1, wherein the controller is configured to, in a case where a predetermined lock trigger is generated when the charging lid is in the unlock state, determine whether or not the vehicle is traveling, switch the charging lid from the unlock state to the lock state when determination is made that the vehicle is not traveling, and not perform switching between the lock state and the unlock state of the charging lid when determination is made that the vehicle is traveling.

3. The vehicle according to claim 2, wherein the controller is configured to, in a case where a predetermined unlock trigger is generated when the charging lid is in the lock state, determine whether or not the vehicle is traveling, switch the charging lid from the lock state to the unlock state when determination is made that the vehicle is not traveling, and not perform switching between the lock state and the unlock state of the charging lid when determination is made that the vehicle is traveling.

4. The vehicle according to claim 3, wherein at least one of the predetermined lock trigger and the predetermined unlock trigger is generated when switching between a lock state and an unlock state of a boarding and unboarding door of the vehicle is performed.

5. The vehicle according to claim 3, further comprising an input device configured to receive an input from a user,
wherein at least one of the predetermined lock trigger and the predetermined unlock trigger is generated when a predetermined input is performed to the input device.

6. The vehicle according to claim 2, further comprising:
a traveling drive device configured to generate traveling drive power of the vehicle using electric power supplied from the electric power storage device; and
a relay configured to switch between connection and cutoff of an electric power path from the electric power storage device to the traveling drive device,
wherein the controller is configured to determine whether or not the vehicle is traveling using a state of the relay.

7. The vehicle according to claim 2, wherein the controller is configured to determine whether or not the vehicle is traveling using at least one of a state of a start switch of the vehicle, a shift position of the vehicle, and a state of a parking brake of the vehicle.
